(19) United States
(12) Patent Application Publication
(10) Pub. No.: US 2003/0054803 A1
(43) Pub. Date: Mar. 20, 2003

(54) Method and system for creating new and enhanced services in a private wireless network

(76) Inventors: Alan Carlton, Colorado Springs, CO (US); Michael Brooking, Colorado Springs, CO (US); Narayan Menon, Colorado Springs, CO (US); Edward Schlein, Monument, CO (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/952,433

(22) Filed: Sep. 14, 2001

(51) Int. Cl. H04Q 7/24

(52) U.S. Cl. 455/414; 370/338

(57) ABSTRACT

A system and method is disclosed that allows and supports the creation of new services and the enhancement of existing services rendered to users of an Office Land Mobile Network (OLMN). A Service Creation Environment (SCE) process is initiated that accesses state information throughout the OLMN and processes requests for services depending upon such state. The SCE communicates with various network elements via triggers that are conditionally satisfied according to state information in the OLMN. A method for supporting services in a Office Land Mobile Network is further disclosed wherein the steps of said method comprising: initiating a process wherein said process accepts service requests from said users; providing communication access points between said process and applications providing said service; accepting as input by said process a plurality of state information concerning users and said Office Land Mobile Network; satisfying said service requests by said users depending on said state information.

### BACKGROUND OF THE INVENTION

Conventional private branch exchanges (PBXs) allow corporations, organizations and other enterprises to provide internal communication services to their personnel. This allows personnel to call each other without using an external public telephone network. Recently, wireless networks and computer networks have been integrated into PBX networks to generate private office networks (called Office Land Mobile Networks—OLMNS) that are capable of providing wireless communications to users of wireless devices with the private office network.

Advanced services are contemplated for these integrated private wireless networks. Such advanced services could either be new services or enhancements to existing services provided by a protocol, such as Wireless Application Protocol (WAP), IP or the like. Such services typically input certain user data such as user location, call management, and native application information and output a wide variety of services in response to such input. For example, it might be desirable for a native application, such as Microsoft Outlook, to send a notice to a subscribed user of the OLMN that the user has a meeting scheduled for a certain time. It might be that the user is logged onto the corporation's IP-based network and/or has its mobile phone activated and registered with the OLMN. In such a case, there is an opportunity to send such notification to either of the user's workstation or to the user's mobile phone, or both.

In Public carrier networks (e.g. GSM, PSTN/ISDN) location, call management based services may be realized via a particular implementation of an Advanced Intelligent Network (AIN) using such protocols as GSM CAMEL. However, for private wireless networks integrated with PBX, and in particular having an IP environment, there is no existing useful framework or architecture in order to support the creation of new services or the extension of existing services.

### SUMMARY OF THE INVENTION

The present invention describes a method and system for creating original services or extending existing services in a Private Wireless Network (e.g. C-GSM). In one embodiment, the network architecture describes an IP based system that may possibly consist of multiple geographically non-contiguous Private domains. A Service Creation Environment (SCE) is defined that utilizes user location, call management and native application information in order to facilitate the creation of new applications by third party development functions. These applications may be completely new applications or merely extensions/enhancements to traditional applications—e.g. Microsoft Outlook. The end-user (e.g. an Office subscriber) may access these new applications via a user data route provided by a protocol such as WAP. Conversely, applications may also access an end user via the same path.

A method for supporting services in an Office Land Mobile Network is further disclosed wherein the steps of said method comprising:

initiating a process wherein said process accepts service requests from said users;

providing communication access points between said process and applications providing said service;

accepting as input by said process a plurality of state information concerning users and said Office Land Mobile Network;

satisfying said service requests by said users depending on said state information.

### BRIEF DESCRIPTION OF THE DRAWINGS

FIG. 1 depicts a typical architecture of an Office Land Mobile Network.

FIG. 2 is a high level conceptual view of the Service Creation Environment that supports the present invention

FIG. 3 depicts a functional architectural embodiment of the Service Creation Environment.

FIG. 4 depicts a structural architectural embodiment of the present invention.

FIG. 5 depicts one embodiment of the present invention as it may relate to a location-based application.

FIG. 6 depicts one possible location-based application of the present invention.

FIG. 7 depicts one embodiment of the present invention as it may relate to a call-management-based application

FIG. 8 depicts one possible call management-based application of the present invention.

### DETAILED DESCRIPTION OF THE INVENTION

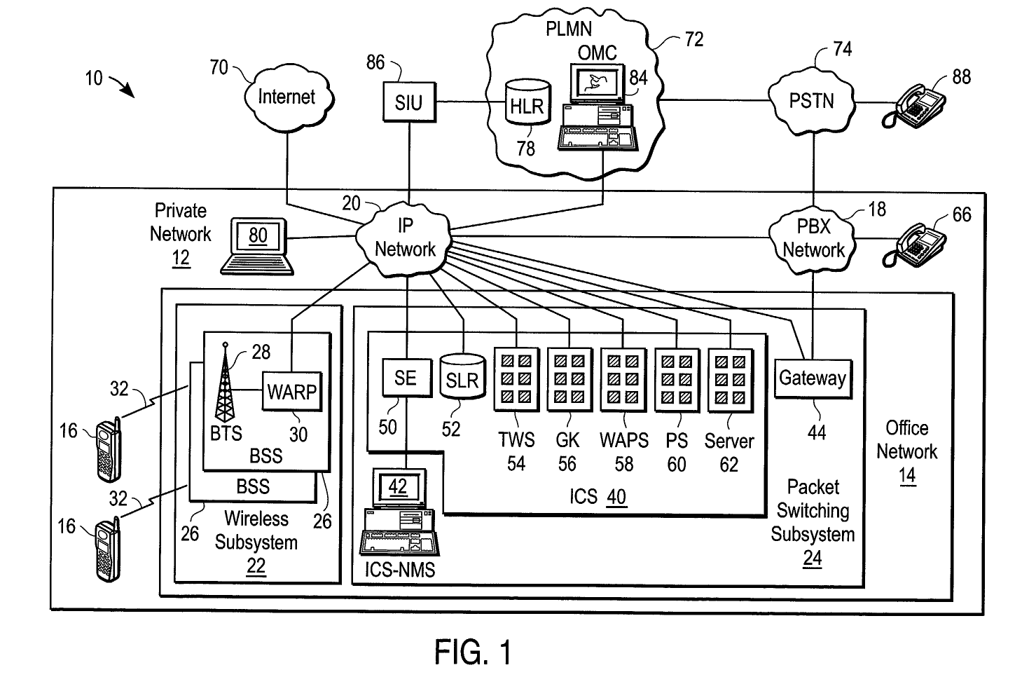

FIG. 1 depicts a typical architecture of an Office Land Mobile Network (e.g. Corporate GSM or “C-GSM”)—illustrating a communication system 10 in accordance with one embodiment of the present invention. The system 10 comprises a private network 12 for providing communication for a plurality of authorized subscribers. According to one embodiment, the private network 12 comprises a communication network for a particular business enterprise and the authorized subscribers comprise business personnel. The private network 12 comprises an office network 14 for providing communication between a plurality of mobile devices 16, a private branch exchange (PBX) network 18, and an Internet Protocol (IP) network 20.

The office network 14 comprises a wireless subsystem 22 for communicating with the mobile devices 16 and a packet switching subsystem 24 for providing operations, administration, maintenance and provisioning (OAMP) functionality for the private network 12. The wireless subsystem 22 comprises one or more base station subsystems (BSS) 26. Each base system subsystem 26 comprises one or more base transceiver stations (BTS), or base stations, 28 and a corresponding wireless adjunct Internet platform (WARP) (alternatively called “IWG”) 30. Each base station 28 is operable to provide communication between the corresponding WARP 30 and mobile devices 16 located in a specified geographical area.

Authorized mobile devices 16 are operable to provide wireless communication within the private network 12 for authorized subscribers. The mobile devices 16 may comprise cellular telephones or other suitable devices capable of providing wireless communication. According to one embodiment, the mobile devices 16 comprise Global System for Mobile communication (GSM) Phase 2 or higher mobile devices 16. Each mobile device 16 is operable to communicate with a base station 28 over a wireless interface 32. The wireless interface 32 may comprise any suitable wireless interface operable to transfer circuit-switched or packet-switched messages between a mobile device 16 and the base station 28. For example, the wireless interface 32 may comprise a GSM/GPRS (GSM/general packet radio service) interface, a GSM/EDGE (GSM/enhanced data rate for GSM evolution) interface, or other suitable interface.

The WARP 30 is operable to provide authorized mobile devices 16 with access to internal and/or external voice and/or data networks by providing voice and/or data messages received from the mobile devices 16 to the IP network 20 and messages received from the IP network 20 to the mobile devices 16. In accordance with one embodiment, the WARP 30 is operable to communicate with the mobile devices 16 through the base station 28 using a circuit-switched protocol and is operable to communicate with the IP network 20 using a packet-switched protocol. For this embodiment, the WARP 30 is operable to perform an interworking function to translate between the circuit-switched and packet-switched protocols. Thus, for example, the WARP 30 may packetize messages from the mobile devices 16 into data packets for transmission to the IP network 20 and may depacketize messages contained in data packets received from the IP network 20 for transmission to the mobile devices 16.

The packet switching subsystem 24 comprises an integrated communication server (ICS) 40, a network management station (NMS) 42, and a PBX gateway (GW) 44. The ICS 40 is operable to integrate a plurality of network elements such that an operator may perform OAMP functions for each of the network elements through the ICS 40. Thus, for example, an operator may perform OAMP functions for the packet switching subsystem 24 through a single interface for the ICS 40 displayed at the NMS 42.

The ICS 40 comprises a plurality of network elements. These network elements may comprise a service engine 50 for providing data services to subscribers and for providing an integrated OAMP interface for an operator, a subscriber location register (SLR) 52 for providing subscriber management functions for the office network 14, a teleworking server (TWS) 54 for providing PBX features through Hicom Feature Access interfacing and functionality, a gatekeeper 56 for coordinating call control functionality, a wireless application protocol server (WAPS) 58 for receiving and transmitting data for WAP subscribers, a push server (PS) 60 for providing server-initiated, or push, transaction functionality for the mobile devices 16, and/or any other suitable server 62.

Each of the network elements 50, 52, 54, 56, 58, 60 and 62 may comprise logic encoded in media. The logic comprises functional instructions for carrying out program tasks. The media comprises computer disks or other computer-readable media, application-specific integrated circuits (ASICs), field-programmable gate arrays (FPGAs), digital signal processors (DSPs), other suitable specific or general purpose processors, transmission media or other suitable media in which logic may be encoded and utilized. As described in more detail below, the ICS 40 may comprise one or more of the servers 54, 58, 60 and 62 based on the types of services to be provided by the office network 14 to subscribers as selected by an operator through the NMS 42.

The gateway 44 is operable to transfer messages between the PBX network 18 and the IP network 20. According to one embodiment, the gateway 44 is operable to communicate with the PBX network 18 using a circuit-switched protocol and with the IP network 20 using a packet-switched protocol. For this embodiment, the gateway 44 is operable to perform an interworking function to translate between the circuit-switched and packet-switched protocols. Thus, for example, the gateway 44 may packetize messages into data packets for transmission to the IP network 20 and may depacketize messages contained in data packets received from the IP network 20.

The communication system 10 may also comprise the Internet 70, a public land mobile network (PLMN) 72, and a public switched telephone network (PSTN) 74. The PLMN 72 is operable to provide communication for mobile devices 16, and the PSTN 74 is operable to provide communication for telephony devices 76, such as standard telephones, clients and computers using modems or digital subscriber line connections. The IP network 20 may be coupled to the Internet 70 and to the PLMN 72 to provide communication between the private network 12 and both the Internet 70 and the PLMN 72. The PSTN 74 may be coupled to the PLMN 72 and to the PBX network 18. Thus, the private network 12 may communicate with the PSTN 74 through the PBX network 18 and/or through the IP network 20 via the PLMN 72.

The PBX network 18 is operable to process circuit-switched messages for the private network 12. The PBX network 18 is coupled to the IP network 20, the packet switching subsystem 24, the PSTN 74, and one or more PBX telephones 78. The PBX network 18 may comprise any suitable network operable to transmit and receive circuit-switched messages. In accordance with one embodiment, the gateway 44 and the gatekeeper 56 may perform the functions of a PBX network 18. For this embodiment, the private network 12 may not comprise a separate PBX network 18.

The IP network 20 is operable to transmit and receive data packets to and from network addresses in the IP network 20. The IP network 20 may comprise a local area network, a wide area network, or any other suitable packet-switched network. In addition to the PBX network 18, the Internet 70 and the PLMN 72, the IP network 20 is coupled to the wireless subsystem 22 and to the packet switching subsystem 24.

The IP network 20 may also be coupled to an external data source 80, either directly or through any other suitable network such as the Internet 70. The external data source 80 is operable to transmit and receive data to and from the IP network 20. The external data source 80 may comprise one or more workstations or other suitable devices that are operable to execute one or more external data applications, such as MICROSOFT EXCHANGE, LOTUS NOTES, or any other suitable external data application. The external data source 80 may also comprise one or more databases, such as a corporate database for the business enterprise, that are operable to store external data in any suitable format. The external data source 80 is external in that the data communicated between the IP network 20 and the external data source 80 is in a format other than an internal format that is processable by the ICS 40.

The PLMN 72 comprises a home location register (HLR) 82 and an operations and maintenance center (OMC) 84. The HLR 82 is operable to coordinate location management, authentication, service management, subscriber management, and any other suitable functions for the PLMN 72. The HLR 82 is also operable to coordinate location management for mobile devices 16 roaming between the private network 12 and the PLMN 72. The OMC 84 is operable to provide management functions for the WARPs 30. The HLR 82 may be coupled to the IP network 20 through an SS7-IP interworking unit (SIU) 86. The SIU 86 interfaces with the WARPs 30 through the IP network 20 and with the PLMN 72 via a mobility-signaling link.

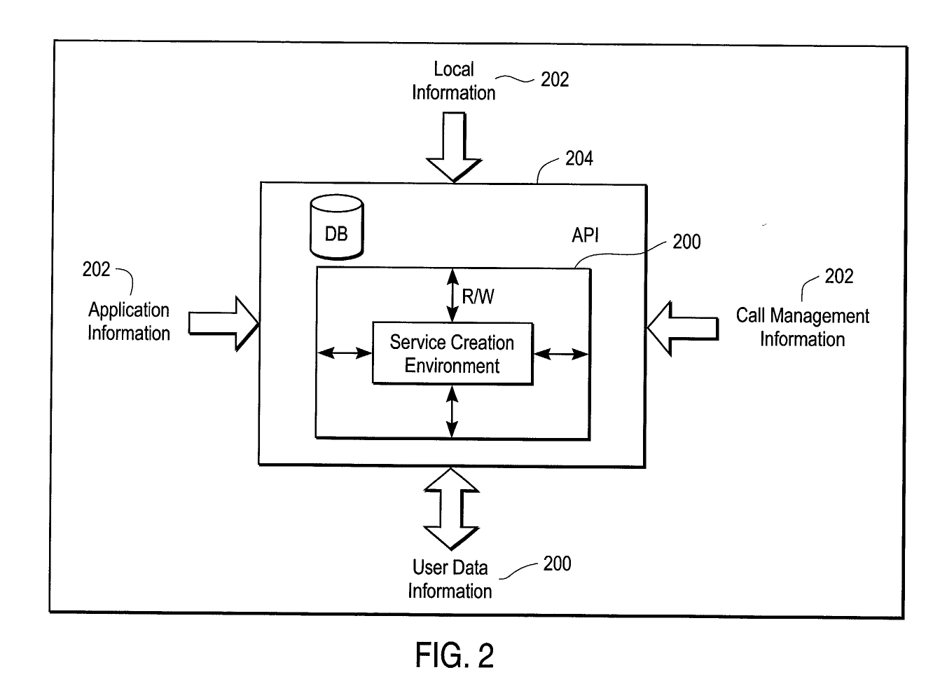

FIG. 2 is a high level conceptual view of the Service Creation Environment (SCE) that supports the present invention. SCE 200 is typically a process that receives as input a myriad of environmental information. For example, SCE 200 could receive as input application, location, call management or user data information 202 through an API 204 to enable the processing of certain advanced user services. In one embodiment of the present invention, SCE 200 could reside as a process within the ICS 40 as previously described. It will also be appreciated that the SCE could be a process running and resident in other parts of the OLMN and that the present invention is not limited by such embodiment. Typically, the user could access these newly enabled services/applications via a user data route provided by a protocol such as a WAP. WAP is used by the MS to access the services provided by the ICS. WAP runs end-to-end between the MS (WAP client) and ICS (WAP Server/Gateway). On the wireless access portion of the C-GSM architecture, WAP uses GSM circuit switched data (CSD) or GPRS as the underlying bearer service. On the WARP—ICS segment, WAP runs over the IP Network.

Conversely, services/applications could access a user via various technologies such as WAP, GPRS and SMS.

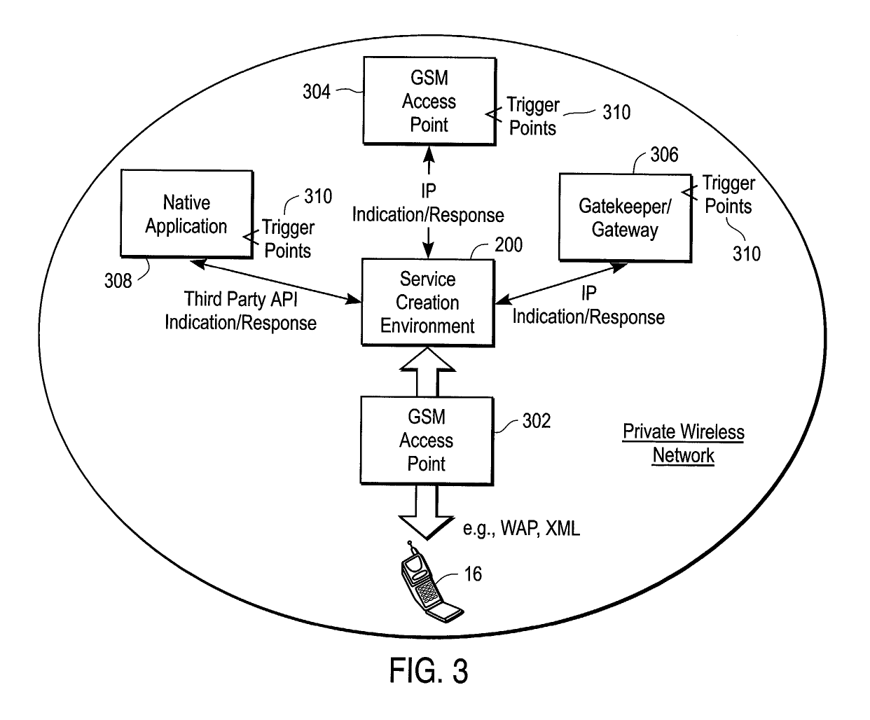

As can be seen in FIG. 3, a functional architectural embodiment of the Service Creation Environment is depicted. SCE 200 communicates with several network elements/entities—e.g. GSM access point 304, Gatekeeper/gateway 310, and native applications 308—via several possible protocols. These network entities, in turn, communicate with other entities and users via trigger points 310 in response to certain events.

During the normal system operation, location information, call management information and native application information will be sent independently by a network entity or function in response to a trigger event in said network entity or function. Respective examples of such trigger events are a user registration event, a call setup event or a native application (e.g. Calendar) notification event. This information could be sent to the SCE 200 over IP or through a third party API. The information may be post processed before being made available to a generic API. New applications or enhancements to commercially available applications may then be realized using this location, call management and native application information. A reciprocal application may be provided in Mobile Station (“MS”) 16. This may be realized via a means such as WAP, XML or another similar protocol. Mobile Station 16 may communicate with the SCE 200 via the same GSM Access Point as where a particular and related event notification was generated. The underlying transmission mechanism supporting this dialogue between MS 16 and the SCE 200 may be realized in part using conventional means such as SMS, Circuit Switched Data or GPRS.

Four Network elements or functions are identified in FIG. 3:

GSM Access Point: GSM Access Point 304 is defined as any network point of termination where GSM user specific information becomes visible (often referred to as layer 3 information). In the C-GSM network, the IWG or a GPRS GSN represents such elements. Generally trigger events will be defined by particular layer 3 signaling events in these elements however a lower level trigger event may be conceived. The notifications may be generated by these elements, as a result of a particular trigger event that relates to Location and Call Management events. Upon the occurrence of a particular trigger event, a notification could be sent over IP to the SCE 200 where some action may subsequently be taken.

Gatekeeper/Gateway: Gatekeeper/Gateway 306 entity is defined as any network point of termination where H.323 user specific information becomes visible (often referred to as layer 3 information). In the C-GSM network, the H.323 Gatekeeper and H.323 Gateway represent such elements. Trigger events may be defined by particular layer 3 signaling events in these elements; however a lower level trigger event may be implemented. As before, the notifications may be generated by these elements, as a result of a particular trigger event that relates to Location and Call Management events. Upon the occurrence of a particular trigger event a notification will be sent over IP to the SCE 200 where some action may subsequently be taken.

Native Application: Native Application 308 is defined as any commercially available application e.g. Microsoft Outlook. These applications provide a published API through which trigger events in the application (e.g. an Outlook notification) may send notifications to a custom software product such as the Service Creation Environment defined within the embodiment of this invention. In the event where the Service Creation Environment is realized in the same software environment as the Native Application, trigger will be communicated directly through software. Alternatively, if these functions are realized in different or geographically discrete environments then trigger events may be communicated over IP.

Service Creation Environment: The Service Creation Environment 200 could be implemented as a software function (or combination hardware/firmware/software) that may be realized via a standalone implementation or may be collocated with one or more of the aforementioned elements or functions. Upon receipt of trigger notifications, SCE 200 may make this information available to third party application (some pre-processing may be provided) via a generic API. Further, where particular third party applications require a one way or a two way dialogue with the Mobile Station then SCE 200 may provide the conduit that the third party application may use to realize an end-to-end exchange. Alternatively, the API will be bi-directional and will provide a transparent means through which end-to-end applications can be realized between Mobile Station and third party applications

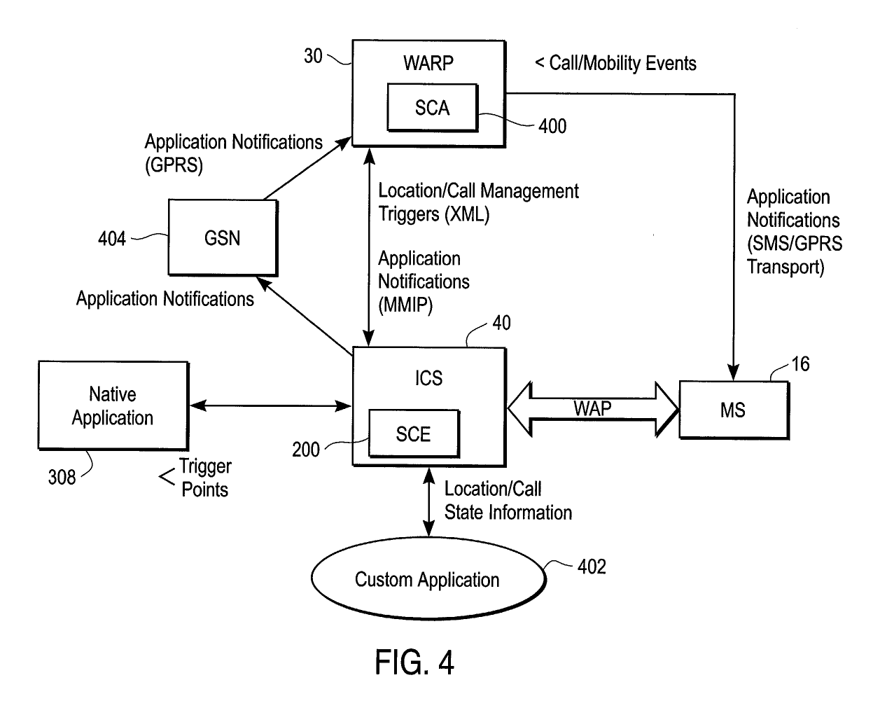

FIG. 4 depicts a structural architectural embodiment of the present invention. As can be seen, in this embodiment, SCE 200 resides in ICS 40 and communicates with several network elements—e.g. WARP 30, Native Applications 308, MS 16 and GPRS Support Nodes (GSN) 404 via numerous communication protocols, WAP, IP, XML triggers, among others. In addition, the SCE might support a custom interface to the native applications integrated into the ICS.

In one aspect of the present embodiment, MS 16 uses WAP to access the ICS applications. WAP allows the Office subscriber to control the operation of the applications running in the ICS, as well as to access information provided by the ICS. WAP utilizes either circuit-switched data (CSD) or General Packet Radio Service (GPRS) as the underlying wireless bearer service.

In addition to WAP, the Office Network uses SMS and/or GPRS to provide “push” type application notifications to the user, where appropriate. For this purpose, a protocol is used between the ICS and WARP, to initiate the SMS/GPRS based forwarding of these notifications from the WARP to the user.

The system architecture also integrates the “mobility” knowledge base that the C-GSM system maintains, with the applications infrastructure provided by the ICS. This results in the support of IP-based applications, that utilize the system's knowledge of the user's location, call state, etc. This mobility knowledge base can be used to provide custom C-GSM applications, and can be also be integrated into native applications (e.g. MS Exchange, Lotus Notes, corporate directory access, etc.) supported by the ICS.

Architecturally, WARP 30 has access to the location and call management information pertaining to the voice and circuit switched data (CSD) services. GSN 404 maintains the session information for the GPRS service. Since the WARP has the overall knowledge of the user's mobility and call management information, the WARP might—in one embodiment of the present invention—support a Service Creation Agent (SCA) 400 function that interfaces into the SCE 200 in the ICS. The support of the SCA in the WARP leads to the transmission of a suite of information at pre-defined trigger points in the call/mobility flow. The ICS is able to process the information contained in these triggers, to provide novel custom applications. Additionally, the mobility information is integrated into native applications, for which ICS interworking is supported. The following SCA—SCE triggers could be supported in this embodiment:

Location information: this will constitute presence information, i.e. indications of whether an Office subscriber has entered or exited the Office Network.

Call management information: this will constitute busy-idle information, i.e. indications of call establishment or release by an Office subscriber.

In the present embodiment, a communications protocol is implemented (for example, in XML) to allow the communication of information between the SCA and SCE functions. XML could serve for the interface between the Service Creation Agent (SCA) in the WARP and the Service Creation Environment (SCE) in the ICS. The service triggers transmitted from the SCA to the SCE could likewise be encapsulated within XML.

As would be well known by those skilled in the art, such a protocol would support the basic triggers outlined above. It will also be appreciated that both the SCE and the SCA may be resident in other parts of the Office Network (i.e. other than the ICS and the WARP respectively) and that the present invention is not dependent on the choice of hosting location of these applications.

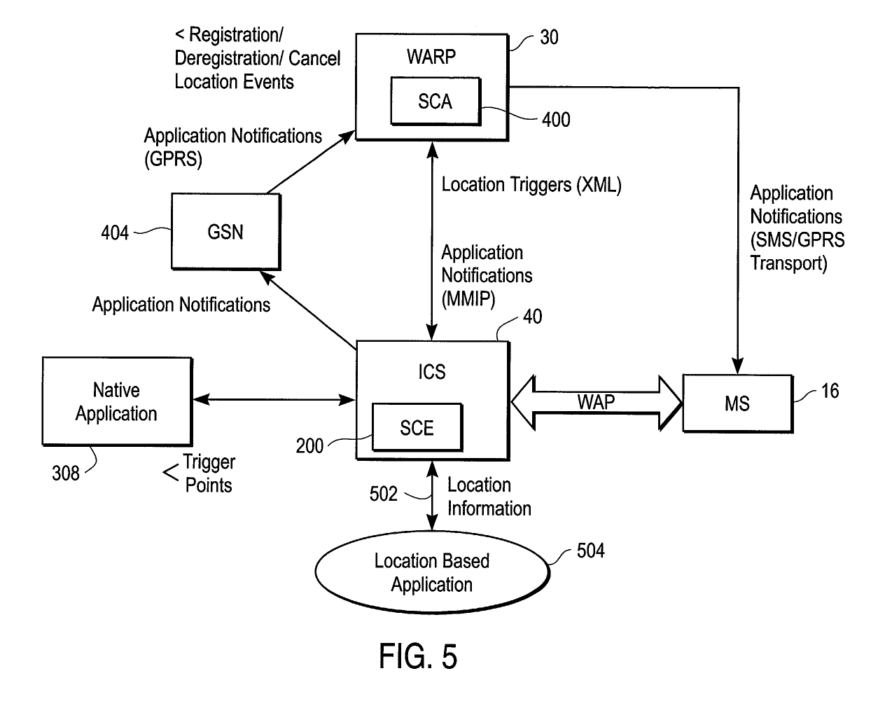

FIG. 5 depicts one embodiment of the present invention as it may relate to a location-based application. As with FIG. 4, the embodiment of FIG. 5 pertains merely to the example of a location-based application architecture. Location based applications 504 typically utilize location information 502 on presence/absence of a user in/from the Office Network, to initiate the transfer of information to the user. SCA 400 function provides this user-specific presence information to SCE 200, when it detects a change in location of the user.

In the present embodiment, WARP 30 issues a location trigger to the ICS when any of the following events occurs:

The Office subscriber (or “Office-sub”) registers with the Office Network.

The Office-sub de-registers from the Office Network (i.e. IMSI Detach as part of power-off, SIM removal, etc.).

The Office-sub roams out of the Office Network, and the Office Network receives a MAP Cancel Location message received from the HLR.

The Office-sub otherwise moves out of Office Network coverage, and the Office Network detects loss of communication with the Office-sub.

The general operation of these location-based applications is given below:

The requesting Office-sub uses WAP to request access to the application. This causes the custom application within the ICS to start monitoring the location of the targeted Office-sub.

The WARP issues a trigger to the ICS, every time the targeted user's location changes. This enables the ICS custom application to have access to the current location of the targeted user.

At determined points of change of the targeted user's location, the custom application sends application notification indications to the WARP or GSN.

The WARP/GSN forwards the embedded text message, using SMS or GPRS respectively, to the requesting user.

Associated features of the present invention include the following:

The Office-sub uses WAP on the MS to access this application.

An Office-sub is able to turn on/off, via WAP, the tracking of their locator, i.e. make themselves locatable/non-locatable.

The Office-sub uses WAP to determine if a target Office-sub is active-on-campus, locator disabled, active-on-PLMN or not active-on-campus.

If the target Office-sub has disabled their locator service, the locator disabled status is returned.

If the target Office-sub is registered on the Office Network, the active-on-campus status is returned.

If the target Office-sub has moved to the PLMN (i.e. the Office Network has received a MAP Cancel Location message indicating the user has moved), the active-on-PLMN status is returned.

If the target Office-sub has de-registered from the Office Network, or otherwise moved out of Office Network coverage, the not active-on-campus status is returned.

An Office-sub, who finds a target Office-sub not active-on-campus, can select the target Office-sub for location notification. When the target Office-sub moves into C-GSM coverage and performs a registration, the location (application) notification is provided to the requesting user, using SMS or GPRS.

Additionally, location information can be integrated into the delivery of native applications that the ICS supports as follows:

The Office-sub uses WAP to request information from the ICS (e.g. corporate directory lookup).

The ICS looks up the latest location state of the Office-sub. The ICS is kept up to date on the user's location information via the triggers sent by the WARP. It integrates the location state of the Office-sub into the information provided to the Office-sub (e.g. corporate directory).

Integration of location information with the Corporate Directory application is thus possible. Each entry in the corporate directory presented to the Office-sub includes the location state (presence/absence in the Office Network) of the person involved, in addition to the person's name and other details.

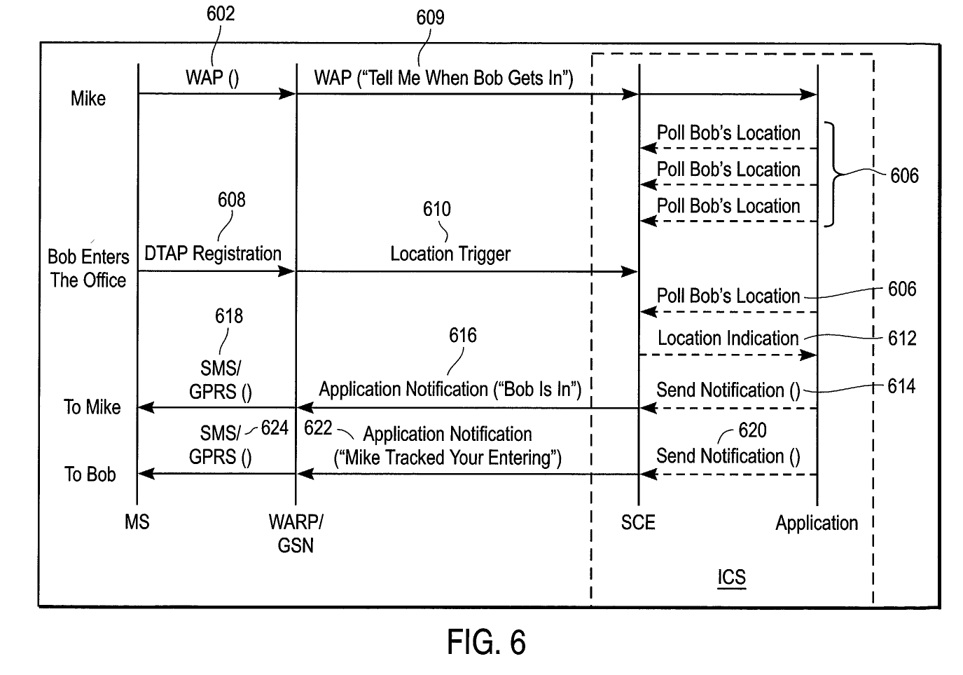

An example of location-based operation is further shown in FIG. 6. In this simple application, an individual (“Mike”) sends a message request to the ICS, requesting notification when a targeted user (“Bob”) becomes active-on-campus, i.e. attaches to the Office Network. Mike, via his MS, sends a request for Bob's registration via WAP to the WARP/GSN and onto the SCE and the application at the ICS at 602 and 604 respectively. The application periodically polls for Bob's location at 606. When Bob enters the office and registers at 608, the location trigger 610 sends that information on to the ICS. A notification is sent from the application at 614 and the SCE sends application notification at 616 back to the WARP and onto Mike (at 618) via SMS, GPRS, or the like. The same notification may take place for Bob at 620, 622 and 624.

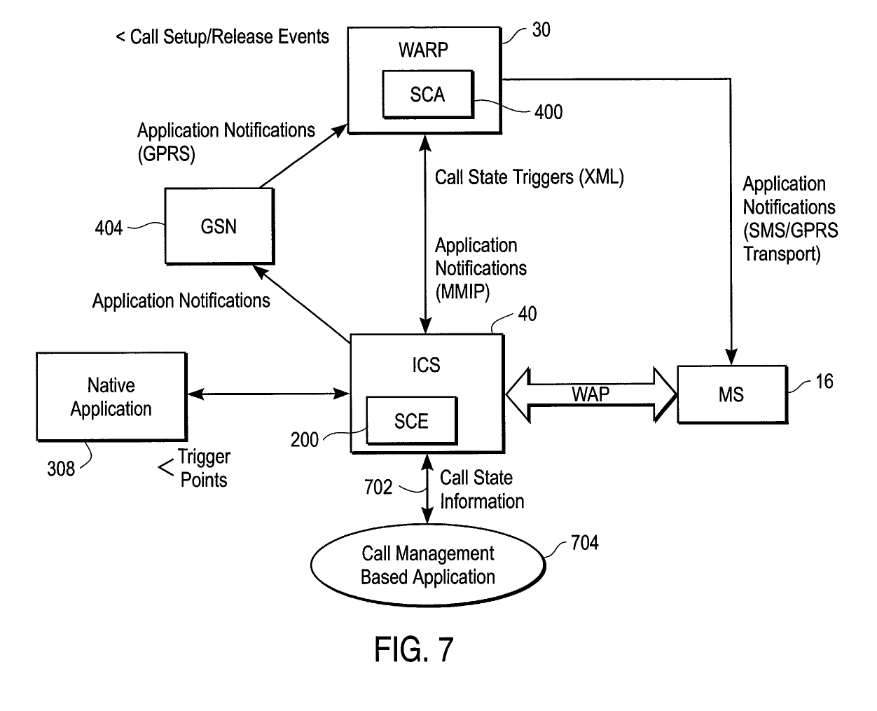

In another aspect of the present invention, FIG. 7 depicts one embodiment of the present invention as it may relate to a call-management-based application. Call management based applications 704 will utilize the information 702 on busy/idle state of a user within the Office Network, to provide services to a requesting user. The WARP's SCA function 400 provides this user-specific call management information to the ICS's SCE 200, when it detects a change in call state of the user.

WARP 30 issues a call management trigger (possibly implemented in XML or some other suitable application) to the ICS 40 when one of a number of possible events occurs. For example, the trigger could occur when the Office-sub successfully establishes a call; or the Office-sub releases a call.

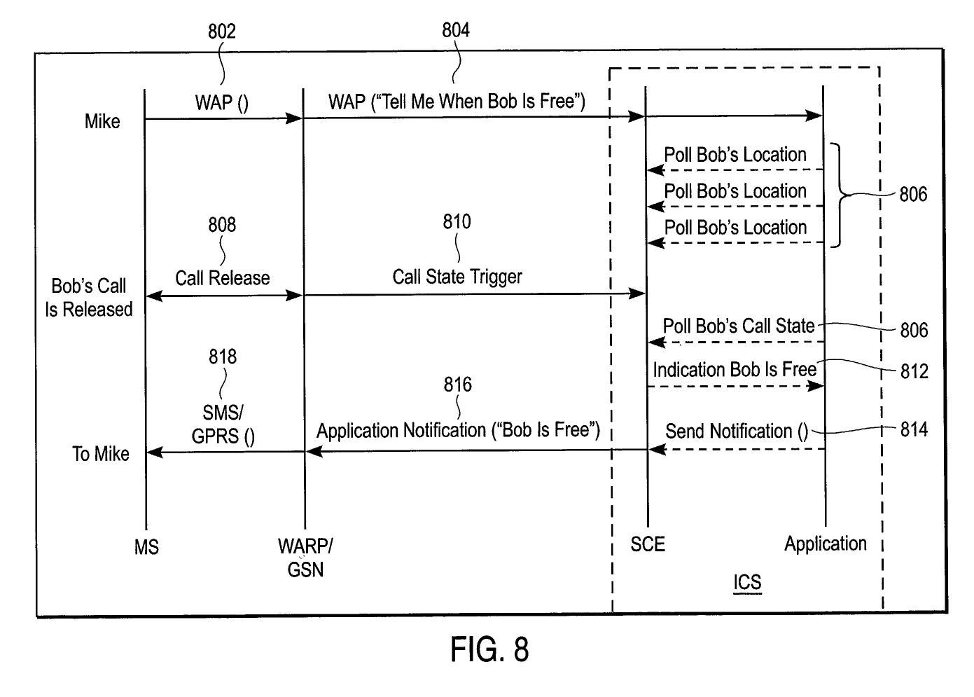

The general operation of these applications is depicted in FIG. 8 with a particular example. To summarize:

The requesting Office-sub uses WAP to request access to the application. This causes the custom application within the ICS to start monitoring the call management state of the targeted Office-sub. In this example, requesting Office-sub, Mike, uses the WAP at 802 to initiate a Notification of a Free Subscriber application. In particular, Mike desires to be notified when Bob is free—possibly via a look-up to the corporate directory.

The WARP issues a trigger to the ICS at 804, every time the targeted user's call management state changes. This enables the ICS custom application to have access to the current call management state of the targeted user at 806.

At determined points of change of the targeted user's call management state at 808, 810, 806 and 812, the custom application sends application notifications to the WARP or GSN at 814 and 816.

The WARP/GSN forwards the embedded text message, using SMS or GPRS respectively, to the requesting user at 818.

It will be appreciated that the ICS could employ application notifications to support services like Instant Messaging, Microsoft Exchange task/meeting reminders, Locator service, Notification of Free Subscriber (NFS), etc. Application notifications could be sent to the Office-sub using SMS or GPRS. If the Office-sub's MS is GPRS-capable, notifications are sent using GPRS. If the Office-sub's MS is not GPRS-capable, SMS could be used. When SMS is used for application notification transfer, the ICS sends the notification to the WARP. The WARP embeds the text message into a mobile-terminated SMS message to the user. When GPRS is used, the ICS forwards the notification to the GSN. The GSN sends the notification over the user's GPRS session, via the WARP to the user.

It has now been disclosed a system and a method for the creation of new services and enhancement of existing services to users of an Office Land Mobile Network. It will be appreciated that the present invention is not limited to the disclosures of the particular embodiments given herein; but, instead, the scope of the present invention encompasses all obvious modifications thereof.

1. In an Office Land Mobile Network wherein users may register and request service and wireless communication via an integrated wired and wireless network, said service being provided by applications residing with said Office Land Mobile Network;
a method for supporting services in a Office Land Mobile Network, the steps of said method comprising:
initiating a process wherein said process accepts service requests from said users;
providing communication access points between said process and applications providing said service;
accepting as input by said process a plurality of state information concerning users and said Office Land Mobile Network;
satisfying said service requests by said users depending on said state information.

2. The method as recited in claim 1 wherein said process resides with an integrated communications server.

3. The method as recited in claim 1 wherein said communication access points are trigger points.

4. The method as recited in claim 1 wherein said state information is application information.

5. The method as recited in claim 1 wherein said state information is call management information.

6. The method as recited in claim 1 wherein said state information is location information.

7. The method as recited in claim 1 wherein said state information is user data information.

8. The method as recited in claim 1 wherein said method further comprises the steps of:
initiating an agent communicating with said process, said agent comprising said state information.

9. The method as recited in claim 8 wherein said agent comprises call management information.

10. The method as recited in claim 8 wherein said agent comprises location information.

11. The method as recited in claim 8 wherein said agent resides in the Wireless Adjunct inteRnet Platform (WARP).

12. A system for providing requested services to users of an Office Land Mobile Network, said system comprising:
a wireless communication subsystem, said wireless subsystem further comprising a Wireless Adjunct inteRnet Platform (WARP);
an IP network connected to said wireless communication subsystem;
a packet switching subsystem, said packet switching subsystem further comprising an ICS, said packet switching subsystem connected to said IP network;
a Service Creation Environment (SCE) process running and resident in said system
wherein said SCE accepts state information regarding said system and provides requested services to said users depending upon said state information.

13. The system as recited in claim 12 wherein said state information further comprises user location information.

14. The system as recited in claim 12 wherein said state information further comprises call management information.

15. The system as recited in claim 12 wherein said state information further comprises application information.

16. The system as recited in claim 12 wherein said state information further comprises user data information.
